(19) United States
(12) Patent Application Publication
(10) Pub. No.: US 2026/0109420 A1
(43) Pub. Date: Apr. 23, 2026

(54) DOOR STRIKER FASTENING APPARATUS, SYSTEM AND METHOD

(71) Applicants: Hyundai Motor Company, Seoul (KR); Kia Corporation, Seoul (KR); Atlascopco, Seongnam (KR)

(72) Inventors: Seok Hyun Jung, Hwaseong (KR); Sang Don Bae, Hwaseong (KR); Ha Yeon Yun, Hwaseong (KR); Myeong Ji Lee, Hwaseong (KR); Jae Min Han, Hwaseong (KR); Deok Hyoun Yoo, Jeonju (KR); Oh Kyun Jeon, Goyang (KR); Ga Ram Han, Bucheon (KR)

(21) Appl. No.: 19/345,228

(22) Filed: Sep. 30, 2025

(30) Foreign Application Priority Data
Oct. 18, 2024 (KR) 10-2024-0143423
Aug. 18, 2025 (KR) 10-2025-0114111

(51) Int. Cl. B62D 65/06

(52) U.S. Cl. CPC B62D 65/06

(57) ABSTRACT

A door striker fastening apparatus, system and method is disclosed. The door striker fastening apparatus includes a gripper including a plurality of nut runners and a permanent magnet, the gripper being configured to simultaneously pick up a door striker and a plurality of bolts fastened to the door striker through the plurality of nut runners and the permanent magnet, a robot configured to transport the door striker and the plurality of bolts picked up through the gripper to a fastening location on a vehicle body, and a processor configured to control driving of the robot or the gripper, based on imaging data obtained through an imaging module, to fasten the door striker and the plurality of bolts to the fastening location.

### CROSS-REFERENCE TO RELATED APPLICATION

This application claims, under 35 U.S. C. § 119(a), the benefit of Korean Patent Application No. 10-2024-0143423, filed Oct. 18, 2024, in the Korean Intellectual Property Office, and Korean Patent Application No. 10-2025-0114111, filed Aug. 18, 2025, in the Korean Intellectual Property Office, the entire contents of which are incorporated herein by reference.

### BACKGROUND

### (a) Technical Field

The present disclosure relates to a technology for fastening a door striker to a vehicle body and, more particularly, to a door striker fastening device, system, and method that may simultaneously pick up a door striker and a plurality of bolts, move the picked-up door striker and bolts to a fastening location, and recognize the fastening location through an imaging module to perform a precise fastening operation.

### (b) Background

Vehicles are necessarily equipped with a door for driver entry and exit, as well as for connection between the vehicle's internal and external environments. To lock the door at a suitable position when opening and closing, a door striker is mounted to a vehicle body. The door striker engages with a door latch when the door is closed, thereby functioning to firmly lock the door of the vehicle. Therefore, precise and highly reliable fastening of the door striker to the vehicle body is essential.

Conventionally, the method primarily used to mount the door striker to the vehicle body involves manually fastening the bolts by a worker. Generally, the door striker is fixed to the vehicle body using two bolts arranged at a narrow spacing of about 31 mm, and a worker must sequentially fasten these bolts within a confined space.

However, with this manual fastening method, there is a risk of scratching or bending the door striker or the vehicle body surface during the process of fastening the bolts by the worker, degrading the exterior quality of the vehicle. Additionally, fastening torque values of the bolts may vary depending on the skill level of the worker and the work environment, making it difficult to ensure consistent fastening quality. Furthermore, repetitive and precise manual fastening increases worker fatigue, which may lead to reduced production efficiency.

Therefore, it is necessary to develop technology capable of automating the process of fastening the door striker to the vehicle body in order to more accurately and rapidly fasten the door striker to the vehicle body, thereby simultaneously enhancing fastening quality and productivity.

### SUMMARY

The present disclosure has been made in an effort to solve the above-described problems associated with the prior art, and an aspect of the present disclosure is to provide a door striker fastening device, system, and method that automate a door striker mounting process to prevent quality degradation caused by manual fastening and to ensure stable bolt fastening even within a narrow fastening spacing, thereby achieving an enhancement in work productivity.

Aspects of the present disclosure are not limited to the above-described aspect, and other aspects of the present disclosure not yet described will be more clearly understood by those skilled in the art (referred to as “skilled persons” hereinafter) from the following detailed description.

In an aspect, the present disclosure provides a door striker fastening apparatus including a gripper including a plurality of nut runners and a permanent magnet, the gripper being configured to simultaneously pick up a door striker and a plurality of bolts fastened to the door striker through the plurality of nut runners and the permanent magnet, a robot configured to transport the door striker and the plurality of bolts picked up through the gripper to a fastening location on a vehicle body, and a processor configured to control driving of the robot or the gripper, based on imaging data obtained through an imaging module, to fasten the door striker and the plurality of bolts to the fastening location.

In a preferred embodiment, the gripper may further include a holding portion corresponding to a shape of a dog of the door striker and may adsorb and hold the door striker through the holding portion and the permanent magnet.

In another preferred embodiment, the holding portion may be configured to dispose the dog of the door striker in a space between the plurality of nut runners.

In still another preferred embodiment, the processor may control driving of the gripper to repeatedly drive the nut runners in forward and reverse rotation directions at a predetermined rotational speed, for fastening of the nut runners to the plurality of bolts.

In yet another preferred embodiment, the gripper may include a cylinder configured to raise or lower the permanent magnet, and the processor may drive the cylinder to lower the permanent magnet after the nut runners are fastened to the plurality of bolts, causing the permanent magnet to attract the door striker.

In yet another preferred embodiment, the plurality of nut runners may be disposed in a first direction identical to a direction in which the plurality of bolts fastened to the door striker is disposed, and the permanent magnet may be disposed in a second direction crossing the first direction to come into contact with a pickup surface of the door striker in order to attract the door striker.

In yet another preferred embodiment, the gripper may include a variable structure configured to vary a position of the nut runners in a height direction in accordance with pressing force generated during a procedure of picking up the plurality of bolts by the plurality of nut runners or fastening the plurality of bolts to the vehicle body by the plurality of nut runners.

In yet another preferred embodiment, the processor may recognize fastening holes of the vehicle body based on the imaging data, and may move the robot or the gripper to the fastening location based on positional relationship between the recognized fastening holes and the plurality of bolts.

In yet another preferred embodiment, the processor may drive the plurality of nut runners at a predetermined torque value to simultaneously fasten the door striker and the plurality of bolts to the vehicle body.

In another aspect, the present disclosure provides a door striker fastening system for automatically fastening a door striker to a vehicle body, including a component supply unit configured to supply the door striker or a plurality of bolts, a gripper configured to simultaneously pick up the door striker supplied from the component supply unit and the plurality of bolts inserted into the door striker and then to fasten the door striker and the plurality of bolts to the vehicle body, a robot configured to transport the door striker and the plurality of bolts picked up through the gripper to a fastening location of the vehicle body, and a processor configured to recognize the fastening location based on imaging data obtained through an imaging module and to control operation of the robot or the gripper based on results of the recognition.

In a preferred embodiment, the component supply unit may include a feeder configured to supply the plurality of bolts, and a supplier configured to align the plurality of bolts supplied from the feeder and then to sequentially supply the aligned bolts.

In another preferred embodiment, the gripper may include a nut runner configured to pick up the plurality of bolts, a permanent magnet configured to pick up the door striker, and a cylinder configured to raise or lower the permanent magnet.

In still another preferred embodiment, the gripper may repeatedly drive the nut runner in forward and reverse rotation directions at a predetermined rotational speed to fasten the nut runner to the plurality of bolts, and the processor may drive the cylinder to lower the permanent magnet, enabling the permanent magnet to attract the door striker.

In yet another preferred embodiment, the processor may recognize fastening holes of the vehicle body through the imaging data, and may move the robot or the gripper to the fastening location based on positional relationship between the recognized fastening holes and the plurality of bolts.

In yet another preferred embodiment, the processor may drive the nut runner (the plurality of nut runners) at a predetermined torque value to simultaneously fasten the plurality of bolts and the door striker to the vehicle body.

In another aspect, the present disclosure provides door striker fastening method for fastening a door striker to a vehicle body, including simultaneously picking up, by a gripper, the door striker and a plurality of bolts fastened to the door striker, transporting, by a robot, the door striker and the plurality of bolts to a fastening location on the vehicle body, recognizing, by the processor, fastening holes of the vehicle body through an imaging module and moving, by the processor, the robot or the gripper to the fastening location based on positional relationship between the recognized fastening holes and the plurality of bolts, and fastening, by the gripper, the door striker and the plurality of bolts to the vehicle body, wherein the gripper includes a nut runner configured to pick up the plurality of bolts, a permanent magnet configured to pick up the door striker, and a cylinder configured to raise or lower the permanent magnet.

In a preferred embodiment, the simultaneously picking up may include repeatedly driving the nut runner in forward and reverse rotation directions at a predetermined rotational speed to fasten the nut runner to the plurality of bolts, and subsequently driving the cylinder to lower the permanent magnet, enabling the permanent magnet to attract the door striker.

In another preferred embodiment, the transporting may include moving, by the processor, the robot or the gripper to the fastening location under a condition that the plurality of bolts is fastened to the nut runner (the plurality of nut runners) and the door striker is adsorbed to the permanent magnet.

In still another preferred embodiment, in the fastening, the gripper may drive the nut runner (the plurality of nut runners) at a predetermined torque value to fasten the plurality of bolts to the vehicle body.

Other aspects and preferred embodiments of the disclosure are discussed infra.

The above and other features of the present disclosure are discussed infra.

In accordance with an aspect, the present disclosure may minimize a fastening location error between the door striker and the vehicle body by simultaneously picking up the door striker and the plurality of bolts, transporting the door striker and the plurality of bolts to the fastening location, precisely recognizing the fastening location through the imaging module, and performing fastening operation based on the recognized fastening location. Accordingly, it may be possible to prevent generation of a gap or looseness during door opening and closing, thereby achieving an enhancement in vehicle assembly quality.

Additionally, during the fastening process, the plurality of nut runners included in the gripper are driven in forward and reverse rotation directions to optimize the alignment between the plurality of bolts and the fastening holes. Additionally, the plurality of bolts is fastened at a predetermined torque value so that the fastening strength thereof may be uniform. Accordingly, it may be possible to prevent a variation in fastening quality.

Furthermore, it may be possible to not only prevent inconsistencies in fastening quality that may arise from differences in worker skill during manual fastening, but also to prevent a risk of scratches or damage to the vehicle body or door striker during the fastening process. Complete automation of the fastening process significantly decreases repetitive tasks for a worker, alleviating worker fatigue and improving the work environment.

According to an aspect of the present disclosure, a door striker fastening apparatus is provided. The door striker fastening apparatus may comprise a gripper, a robot configured to transport a door striker and a plurality of bolts, picked up through the gripper, to a fastening location on a vehicle body, and a computing device comprising a processor and a memory. The memory may be configured to store instructions that, when executed by the processor, are configured to cause the processor to control driving of the robot or the gripper, based on imaging data obtained through an imaging module, to fasten the door striker and the plurality of bolts to the fastening location.

According to an exemplary embodiment, the gripper may comprise a plurality of nut runners and a permanent magnet. The gripper may be configured to pick up the door striker and the plurality of bolts, fastened to the door striker, through the plurality of nut runners and the permanent magnet.

According to an exemplary embodiment, the gripper may comprise a holding portion corresponding to a shape of a dog of the door striker, and the holding portion may be configured to adsorb and hold the door striker through the holding portion and the permanent magnet.

According to an exemplary embodiment, the holding portion may be configured to dispose the dog of the door striker in a space between the plurality of nut runners.

According to an exemplary embodiment, the computing device may be configured to control driving of the gripper to repeatedly drive the nut runners in forward and reverse rotation directions at a predetermined rotational speed, for fastening of the nut runners to the plurality of bolts.

According to an exemplary embodiment, the gripper may comprise a cylinder configured to raise or lower the permanent magnet, and the computing device may be configured to drive the cylinder to lower the permanent magnet after the nut runners are fastened to the plurality of bolts, causing the permanent magnet to attract the door striker.

According to an exemplary embodiment, the plurality of nut runners may be disposed in a first direction identical to a direction in which the plurality of bolts fastened to the door striker is disposed, and the permanent magnet may be disposed in a second direction crossing the first direction to come into contact with a pickup surface of the door striker in order to attract the door striker.

According to an exemplary embodiment, the gripper may comprise a variable structure configured to vary a position of the nut runners in a height direction in accordance with a pressing force generated during a procedure of picking up the plurality of bolts by the plurality of nut runners or fastening the plurality of bolts to the vehicle body by the plurality of nut runners.

According to an exemplary embodiment, the computer may be configured to recognize one or more fastening holes of the vehicle body based on the imaging data, and move the robot or the gripper to the fastening location based on a positional relationship between the recognized one or more fastening holes and the plurality of bolts.

According to an exemplary embodiment, the computing device may be configured to drive the plurality of nut runners at a predetermined torque value to simultaneously fasten the door striker and the plurality of bolts to the vehicle body.

According to an exemplary embodiment, a door striker fastening system for automatically fastening a door striker to a vehicle body is provided. The door striker fastening system may comprise a component supply unit configured to supply a door striker or a plurality of bolts, a gripper, a robot configured to transport the door striker and the plurality of bolts, picked up through the gripper, to a fastening location of a vehicle body, and a computing device, comprising a processor and a memory. The memory may be configured to store instructions that, when executed by the processor, are configured to cause the processor to recognize the fastening location based on imaging data obtained through an imaging module, and control operation of the robot or the gripper based on results of the recognition.

According to an exemplary embodiment, the gripper may be configured to simultaneously pick up the door striker, supplied from the component supply unit, and the plurality of bolts inserted into the door striker and then fasten the door striker and the plurality of bolts to the vehicle body.

According to an exemplary embodiment, the component supply unit may comprise a feeder configured to supply the plurality of bolts, and a supplier configured to align the plurality of bolts supplied from the feeder and sequentially supply the aligned bolts.

According to an exemplary embodiment, the gripper may comprise a nut runner configured to pick up the plurality of bolts, a permanent magnet configured to pick up the door striker, and a cylinder configured to raise or lower the permanent magnet.

According to an exemplary embodiment, the gripper may be configured to repeatedly drive the nut runner in forward and reverse rotation directions at a predetermined rotational speed to fasten the nut runner to the plurality of bolts, and the computing device may be configured to drive the cylinder to lower the permanent magnet, enabling the permanent magnet to attract the door striker.

According to an exemplary embodiment, the computing device may be configured to recognize one or more fastening holes of the vehicle body through the imaging data, and move the robot or the gripper to the fastening location based on a positional relationship between the recognized fastening holes and the plurality of bolts.

According to an aspect of the present disclosure, a method for fastening a door striker to a vehicle body is provided. The method may comprise transporting, by a robot, a door striker and a plurality of bolts to a fastening location of a vehicle body, moving, by a computing device comprising a processor and a memory, the robot or a gripper to the fastening location based on a positional relationship between fastening holes recognized through an imaging module and the plurality of bolts, and fastening, by the gripper, the door striker and the plurality of bolts to the vehicle body.

According to an exemplary embodiment, the method may comprise picking up, by the gripper, the door striker and a plurality of bolts fastened to the door striker. The gripper may comprise a nut runner configured to pick up the plurality of bolts, a permanent magnet configured to pick up the door striker, and a cylinder configured to raise or lower the permanent magnet.

According to an exemplary embodiment, the picking up may comprise repeatedly driving the nut runner in forward and reverse rotation directions at a predetermined rotational speed to fasten the nut runner to the plurality of bolts, and subsequently driving the cylinder to lower the permanent magnet, enabling the permanent magnet to attract the door striker.

According to an exemplary embodiment, the transporting may comprise moving, by the computing device, the robot or the gripper to the fastening location when the plurality of bolts is fastened to the nut runner and the door striker is adsorbed to the permanent magnet.

According to an exemplary embodiment, the fastening may comprise driving, by the gripper, the nut runner at a predetermined torque value to fasten the plurality of bolts to the vehicle body.

However, the effects that can be obtained through the present disclosure are not limited to the aforementioned effects, and other unmentioned technical effects will be clearly understood by those skilled in the art from the description of the disclosure provided below.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a block diagram of a door striker fastening device, according to an exemplary embodiment of the present disclosure.

FIGS. 2 and 3 illustrate views explaining the door striker fastening device, according to an exemplary embodiment of the present disclosure.

FIG. 4 illustrates a block diagram of a door striker fastening system, according to an exemplary embodiment of the present disclosure.

FIG. 5 illustrates a view explaining the door striker fastening system, according to an exemplary embodiment of the present disclosure.

FIG. 6 illustrates a flowchart explaining a door striker fastening method, according to an exemplary embodiment of the present disclosure.

FIG. 7 illustrates example elements of a computing device, according to an exemplary embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, preferred embodiments of the present disclosure will be described in detail with reference to the accompanying drawings. The terms or words used in this specification and claims should not be construed as being limited to the usual or dictionary meaning and should be interpreted as having a meaning and concept consistent with the technical idea of the present disclosure based on the principle that the inventor can be his/her own lexicographer to appropriately define the concept of the term. Therefore, the embodiments described in this specification and the configurations shown in the drawings are provided as some example embodiments of the present disclosure and do not necessarily represent all of the technical ideas of the present disclosure. Accordingly, it is to be understood that there may be various equivalents and modifications that may replace or modify the embodiments described herein at the time of filing this application. It is to be further understood that the terms “comprise” (or “include”) and/or “comprising” (or “including”), when used in this specification, specify the presence of stated features, integers, steps, operations, elements, and/or components, but do not preclude the presence or addition of one or more other features, integers, steps, operations, elements, components, and/or groups thereof. Further, the use of “may” when describing embodiments of the present disclosure relates to “one or more embodiments of the present disclosure.”

In the figures, dimensions of some elements may be exaggerated for clarity of understanding of the present disclosure. In different embodiments, the same reference numerals designate the same or like elements.

References to two compared elements as being “the same” may mean that they are substantially the same. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It is to be understood that, although the terms “first,” “second,” etc. may be used herein to describe various elements, these elements should not be limited by these terms. These terms are used to distinguish one element from another element. Thus, a first element discussed below could be termed a second element, unless otherwise specifically noted.

Throughout the specification, unless otherwise specifically noted, each element may be singular or plural.

When an arbitrary element is referred to as being disposed on the “above (or below)” or “on (or under)” a component, it may mean that the arbitrary element is disposed in contact with the upper (or lower) surface of the component and may also mean that another component may be interposed between the component and any arbitrary element disposed on (or under) the component.

The term “and/or” is used to include any combination of multiple items that are subject to it. For example, “A and/or B” may include all three cases, for example, “A,” “B,” and “A and B.”

When a component is described as “coupled” or “connected” to another component, the component may be directly coupled or connected to the other component. However, it is to be understood that another component may be present therebetween. In contrast, when a component is described as “directly coupled” or “directly connected” to another component, it is to be understood that there are no other components therebetween.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the other part are indirectly electrically connected to each other.

In addition, the term “unit,” “control unit,” “control device,” or “controller” is merely a widely used term for naming an element or component that controls a specific function, and does not mean a generic functional unit. For example, each controller may include a communication device that communicates with another controller or a sensor to control a function assigned thereto, a computer-readable recording medium that stores an operating system (OS), logic commands, input/output information, and the like, and at least one processor that performs determination, calculation, computation, decision, and the like that are necessary for controlling a function assigned thereto.

Meanwhile, the processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, the computer-readable recording medium (or simply a “memory”) may include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

Hereinafter, various embodiments of the present disclosure will be described in detail with reference to the accompanying drawings.

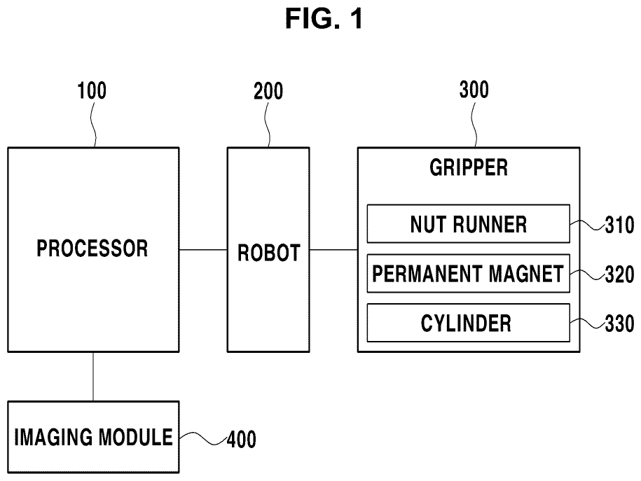

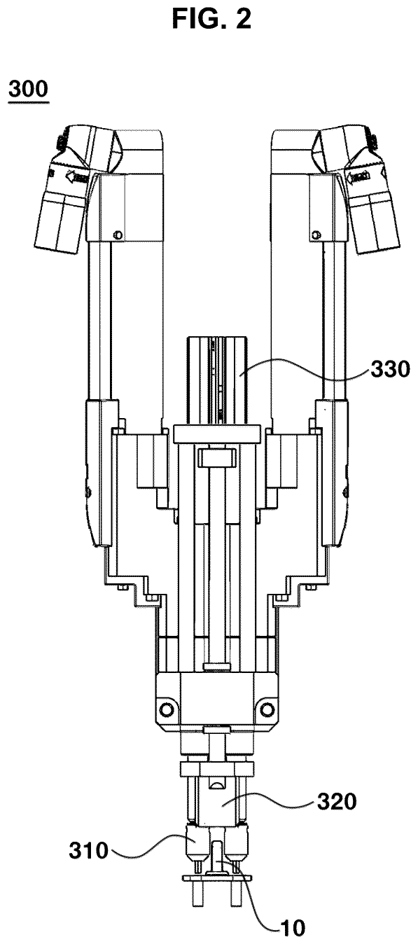

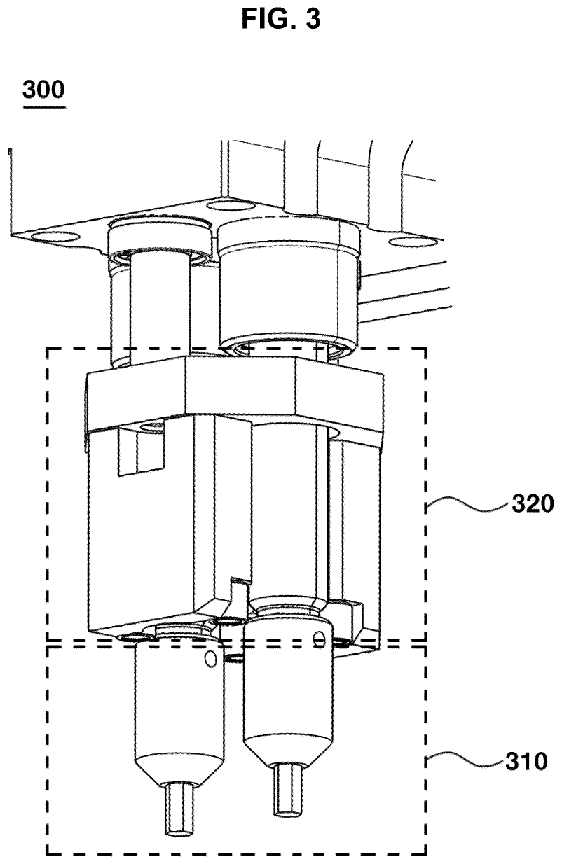

FIG. 1 illustrates a block diagram of a door striker fastening device, according to an exemplary embodiment of the present disclosure. FIGS. 2 and 3 illustrate views explaining the door striker fastening device, according to an exemplary embodiment of the present disclosure.

Referring first to FIG. 1, the door striker fastening device, according to an exemplary embodiment of the present disclosure, may comprise a processor 100, a robot 200, a gripper 300, and an imaging module 400.

The processor 100 may be a subject configured to control operation of the robot 200 or the gripper 300 to pick up a door striker and a plurality of bolts and to control an operation for fastening the door striker and the plurality of bolts to a vehicle body based on imaging data obtained through the imaging module 400.

Various embodiments described in this specification may be implemented as software including one or more commands stored in a storage medium (e.g., internal or external memory) readable by a machine (e.g., a computing device or the processor 100). For example, the machine or the processor 100 may be configured to retrieve at least one command from the stored commands in the storage medium and may execute the retrieved command. The at least one command may comprise code generated by a compiler or code executable by an interpreter. The storage medium readable by the machine or the processor 100 may be provided in the form of a non-transitory storage medium. Here, the term “non-transitory” means that the storage medium is a tangible device and does not include signals (e.g., electromagnetic waves), and this term does not distinguish between the case in which data is semi-permanently stored in the storage medium and the case in which data is temporarily stored in the storage medium.

The processor 100 may comprise hardware (e.g., a controller or the like) configured to implement the various embodiments described in this specification. The processor 100 may be constituted by one or more cores and may comprise one or more processors designed and configured for data analysis and deep learning, such as a central processing unit (CPU), a general-purpose graphics processing unit (GPGPU), a tensor processing unit (TPU), an application processor (AP), an application-specific integrated circuit (ASIC), a field-programmable gate array (FPGA), etc. The processor intended for deep learning may be configured to be controlled to process input data in accordance with predefined operational rules stored in memory or based on an artificial intelligence (AI) model. When one or more processors are dedicated AI processors, the processors may be designed with hardware architectures optimized for executing specific AI models.

The memory may be configured to store various information and maps required to implement the various embodiments described in this specification. The memory may comprise at least one type of storage medium, such as flash memory, hard disk, multimedia card micro types, card-type memory (e.g., SD or XD memory or the like), random access memory (RAM), static random access memory (SRAM), dynamic random access memory (DRAM), magnetic random access memory (MRAM), read-only memory (ROM), electrically erasable programmable read-only memory (EEPROM), programmable read-only memory (PROM), magnetic memory, a magnetic disk, and an optical disc. Additionally, the memory may comprise any computer-readable recording medium well-known in the technological field associated with the present disclosure. Additionally, examples of storage or recording media comprise media managed by app stores that distribute or supply applications or other sites, servers, etc. that distribute or supply various software. The above description of the memory is only illustrative, and the present disclosure is not limited thereto.

The robot 200 may correspond to a configuration configured to transport the door striker and the plurality of bolts picked up by the gripper 300 to a fastening location. The robot 200, according to an exemplary embodiment, may be configured to be implemented as a multi-joint robot (e.g., UR20) capable of performing collaborative operation, and operation of the robot 200 may be controlled by the processor 100.

The gripper 300 may correspond to a configuration configured to simultaneously pick up the door striker and the plurality of bolts and to perform an operation for fastening the picked-up door striker and plurality of bolts to the fastening location. The gripper 300 may comprise a plurality of nut runners 310, a permanent magnet 320, and a cylinder 330.

Specifically, the plurality of nut runners 310 may correspond to a configuration configured to pick up the plurality of bolts fastened to the door striker under control of the processor 100 and then to perform a driving operation for fastening the plurality of bolts to the vehicle body under the condition that the plurality of bolts has been transported to the fastening location. Referring to FIGS. 2 and 3, in an exemplary embodiment of the present disclosure, the plurality of nut runners 310 may be configured as two units. That is, the plurality of nut runners 310 may be set to correspond to the number of bolts to be fastened to the door striker, and the number of the plurality of nut runners 310 may be adjusted as necessary. The nut runners 310 may be disposed to be spaced apart from each other to match the spacing between the plurality of bolts inserted into the door striker (e.g., a bolt pitch or a center-to-center distance). Additionally, bits of the nut runners 310 may be formed to correspond to the shape of fastening portions of the bolts, which are objects to be fastened, in order to ensure stable fastening.

The gripper 300 may further comprise a holding portion (not shown) corresponding to the shape of a dog 10 of the door striker. This holding portion may mean a space between the plurality of nut runners 310. When the dog 10 of the door striker may be disposed within the holding portion, the gripper 300 may be configured to stably grasp the door striker during a procedure of transporting the gripper 300 to the fastening location. The holding portion may have a shape corresponding to the dog 10 protruding from a surface of the door striker. The cross-section of the holding portion may have a “C” shape. The door striker may be adsorbed and fixed to the gripper 300 through the holding portion and the permanent magnet 320. In this case, the permanent magnet 320 may correspond to a configuration configured to function to attract and pick up the door striker.

Meanwhile, the plurality of nut runners 310, according to an exemplary embodiment of the present disclosure, may be disposed in a first direction identical to a direction in which the plurality of bolts fastened to the door striker is disposed. The permanent magnet 320 may be disposed in a second direction crossing the first direction and, as such, may come into contact with a pickup surface of the door striker. More specifically, the plurality of nut runners 310 may be disposed in the first direction identical to a bolt fastening direction of the door striker so that the plurality of nut runners 310 may fasten the bolts inserted into the door striker to the vehicle body. Accordingly, the permanent magnet 320 may be disposed in the second direction orthogonally intersecting or crossing the first direction so that the permanent magnet 320 may come into contact with the pickup surface of the door striker. In accordance with the above-described arrangement structure, the permanent magnet 320 may be configured to stably come into contact with the pickup surface of the door striker and, as such, may attract the door striker.

Meanwhile, the arrangement structure between the plurality of nut runners 310 and the permanent magnet 320 is not limited to the above illustration. The arrangement structure between the plurality of nut runners 310 and the permanent magnet 320 may be diversely varied so long as the varied arrangement structure facilitates easy pickup and fastening of the door striker.

The cylinder 330 may be a configuration configured to control upward or downward movement of the permanent magnet 320. During a procedure of picking up the door striker or fastening the door striker to the vehicle body, the cylinder 330 may be configured to move the permanent magnet 320 upwards or downwards. Specifically, before the door striker is fastened to the vehicle body, the cylinder 330 may be configured to raise the permanent magnet 320 under control of the processor 100 to release contact between the door striker and the magnet 320. During a fastening process, the cylinder 330 may be configured to lower the permanent magnet 320 to adsorb the door striker onto the permanent magnet 320, enabling the gripper 300 to stably hold the door striker.

The imaging module 400 may correspond to a configuration configured to obtain image data related to the door striker, the plurality of bolts and a fastening location of the vehicle body and to transmit the obtained image data to the processor 100. The processor 100 may be configured to analyze the image data obtained through the imaging module 400 to recognize the fastening location of the vehicle body, and may be configured to accurately control operation of the robot 200 and the gripper 300 based on the recognized fastening location. In particular, the imaging module 400 may be configured to identify fastening holes of the vehicle body and may be configured to transmit data about the identified holes to the processor 100. The imaging module 400, according to an exemplary embodiment of the present disclosure, may be implemented using an imaging module well known in the field of robotics (e.g., a vision module) and, as such, a detailed description thereof will be omitted.

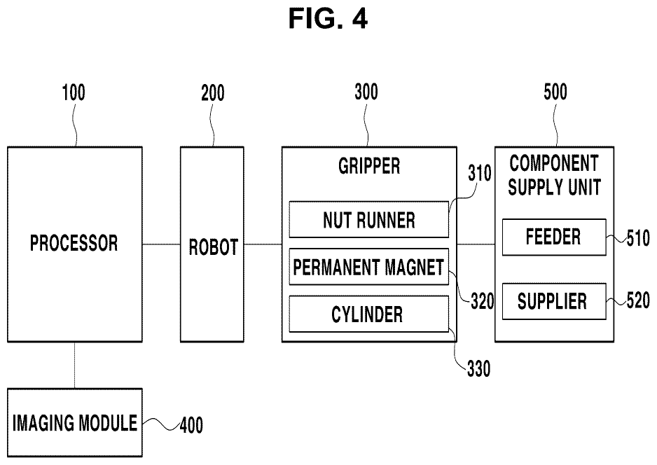

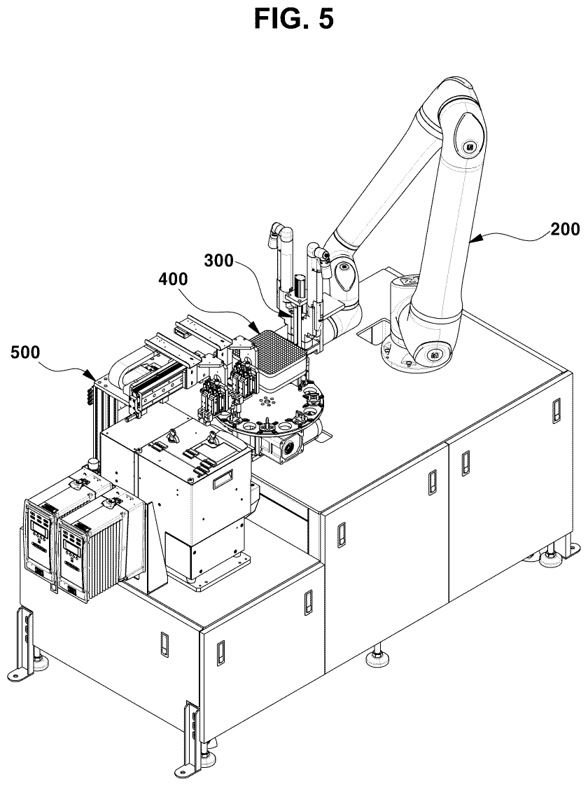

FIG. 4 illustrates a block diagram of a door striker fastening system, according to an exemplary embodiment of the present disclosure. FIG. 5 illustrates a view explaining the door striker fastening system, according to an exemplary embodiment of the present disclosure. Based on the foregoing description, the door striker fastening system of this embodiment will be described with reference to FIGS. 4 and 5. Detailed descriptions of parts overlapping with the above description will be omitted.

Referring to FIGS. 4 and 5, the door striker fastening system, according to an exemplary embodiment of the present disclosure, may comprise a processor 100, a robot 200, a gripper 300, an imaging module 400, and a component supply unit 500.

The component supply unit 500 may be a configuration configured to smoothly supply a plurality of bolts used for door striker fastening. The component supply unit 500 may comprise a feeder 510 configured to store and supply a plurality of bolts, and a supplier 520 configured to align bolts supplied from the feeder 510 and to sequentially deliver the aligned bolts.

The feeder 510 may comprise a bunker configured to accommodate a plurality of bolts. The feeder 510 may be configured to function to automatically align the bolts loaded in the bunker and to supply the aligned bolts in a transportable state. Although a worker simply loads a large quantity of bolts into the bunker through the feeder 510, the bolts may be automatically aligned and supplied.

The supplier 520 may correspond to a configuration configured to pick up and align bolts sequentially supplied from the feeder 510 and then to transfer the bolts to a predetermined position (e.g., a placement position) that facilitates easy pickup of the bolts by the robot 200 or the gripper 300. Specifically, the supplier 520 may be constituted by X, Y, and Z-axis cylinders and an electromagnet. The X and Y-axis cylinders may be configured to adjust a bolt pickup position and a placement position, whereas the Z-axis cylinder may be configured to perform pickup and transfer operations. The electromagnet may be configured to control pickup and release of the bolts, enabling conveyance or ejection of the bolts at precise timing. The supplier 520, according to an exemplary embodiment of the present disclosure, may be implemented as, for example, an escape device. The component supply unit 500 may be implemented through various supply mechanisms widely known in robotics and automation fields and, as such, detailed descriptions of such mechanisms will be omitted herein.

The processor 100 may be configured to control driving of the gripper 300 to repeatedly drive the plurality of nut runners 310 in forward and reverse rotation directions at a predetermined rotational speed. To this end, the plurality of nut runners 310 may be implemented as a configuration capable of achieving precise torque control (e.g., Atlas Copco QST42-20COT-T50L134-H10). The forward rotation may be carried out to achieve driving for coupling bits of the plurality of nut runners 310 with bolts fastened to the door striker to initiate fastening. Conversely, the reverse rotation may be carried out to achieve operation of stabilizing an engagement state between each bit and each bolt during fastening and finely adjusting the fastening position of each bolt. Under control of the processor 100, the plurality of nut runners 310 may be configured to perform precise fastening until reaching a predetermined torque. Through this process, the bits of the plurality of nut runners 310 may be accurately fastened to the plurality of bolts, respectively.

After the plurality of nut runners 310 has been fastened to the bolts, respectively, the processor 100 may be configured to drive the cylinder 330 to lower the permanent magnet 320. Based on a control signal from the processor 100, the cylinder 330 may be configured to precisely move the permanent magnet 320 to a predetermined lowered position, ensuring close contact between the pickup surface of the door striker and the permanent magnet 320. Once the lowering operation is completed, the permanent magnet 320 may be configured to attract the door striker through magnetic force thereof, enabling the door striker to be stably fixed to the gripper 300.

The robot 200 may be configured to transport the door striker and the plurality of bolts picked up by the gripper 300 to a fastening location on a vehicle body. That is, the robot 200 may be configured to simultaneously move the door striker adsorbed onto the permanent magnet 320, together with the plurality of bolts fastened to the plurality of nut runners 310, to the fastening location.

The processor 100 may be configured to recognize the fastening location based on imaging data obtained through the imaging module 400. The imaging module 400 may be configured to capture high-precision images of fastening holes formed at the vehicle body and their surrounding features, and may be configured to provide coordinate information about the fastening location to the processor 100.

The processor 100 may be configured to analyze the imaging data to accurately recognize positions of the fastening holes. Based on the positional relationship between the recognized fastening holes and the plurality of bolts, the processor 100 may be configured to control operation of the robot 200 or the gripper 300 to precisely move the door striker and the plurality of bolts to the fastening location.

The processor 100 may be configured to perform a task of simultaneously fastening the door striker and the plurality of bolts fastened to the door striker to the fastening location on the vehicle body. During this process, the plurality of bolts may be held in a fastened state by the plurality of nut runners 310, and the door striker may be held in an adsorbed state by the permanent magnet 320. That is, the processor 100 may be configured to control rotation operation of the plurality of nut runners 310 to fasten the plurality of bolts to the fastening location under the condition that the door striker and the plurality of bolts are maintained in a state of being fixed to the gripper 300. As the plurality of bots is fastened, the door striker may be automatically fixed to the vehicle body.

For stable fastening, the gripper 300 may comprise a variable structure configured to allow the vertical position of the plurality of nut runners 310 to be adjusted. Here, the variable structure may mean a structure configured to absorb axial pressing force generated during the process of fastening the plurality of bolts in accordance with pressing force generated when the plurality of nut runners 310 picks up the plurality of bolts or fastens the plurality of bolts to the vehicle body. For example, the variable structure may comprise a telescopic mechanism and a spring structure. Specifically, the plurality of nut runners 310 may be configured to absorb, through the spring structure, pressing force caused by position deviation or fastening resistance generated between the bolts and the fastening holes of the vehicle body during fastening operation. Additionally, the spring structure, which absorbs pressing force, may be configured to also elastically move the plurality of nut runners 310 in a height direction through restoring force thereof.

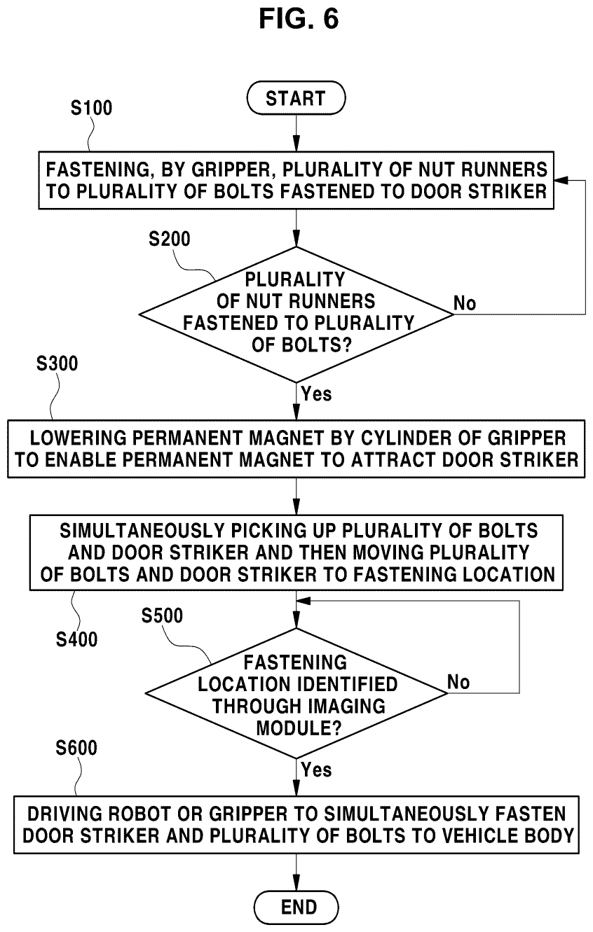

FIG. 6 illustrates a flowchart explaining a door striker fastening method, according to an exemplary embodiment of the present disclosure. Hereinafter, the door striker fastening method of this embodiment will be described with reference to FIG. 6. Detailed descriptions of parts overlapping with the above description will be omitted, and the following description will be given in conjunction with time-series configurations.

A gripper 300 may be configured to utilize a plurality of nut runners 310 configured to correspond to a plurality of bolts pre-assembled to a door striker, to fasten respective bits of the plurality of nut runners 310 to the plurality of bolts (S100). A processor 100 may be configured to verify, in real-time, whether each bit of the plurality of nut runners 310 is accurately coupled to a corresponding one of the plurality of bolts, simultaneously with controlling fastening operation of the plurality of nut runners 310. Additionally, the processor 100 may be configured to determine whether fastening has been completed, based on whether a target fastening torque has been reached, a bit insertion status, etc. (S200).

When all of the plurality of bolts are precisely fastened to the plurality of nut runners 310, the processor 100 may be configured to control the cylinder 330 to lower the permanent magnet 320 under the condition that the fastening state is maintained. The permanent magnet 320 may be configured to come into contact with a pickup surface of the door striker through downward movement thereof by the cylinder 330. During this procedure, the permanent magnet 320 may be configured to magnetically attract the door striker through magnetic force (S300). In step S300, the door striker may be stably fixed by the permanent magnet 320, and the plurality of bolts may be completely picked up by the gripper 300 in a state of being fastened to the nut runners 310.

The processor 100 may be configured to control the robot 200 to transfer, to a fastening location on the vehicle body, the plurality of bolts fastened to the plurality of nut runners 310 and the door striker adsorbed onto the permanent magnet 320. The robot 200 may be precisely driven based on a predetermined path set under control of the processor 100 and, as such, may stably transport the door striker and the plurality of bolts to the fastening location (S400).

When the robot 200 approaches the vicinity of the fastening location, the processor 100 may be configured to analyze imaging data obtained through an imaging module 400 to accurately recognize positions of fastening holes of the vehicle body. The imaging module 400 may be configured to detect shapes and positions of the fastening holes using a high-precision 3D vision system or the like (S500).

Based on data received from the imaging module 400, the processor 100 may be configured to finely drive the robot 200 or the gripper 300 to perform fastening alignment.

Once the fastening alignment is completed, the processor 100 may be configured to control the plurality of nut runners 310 to perform rotational driving in order to perform a task of simultaneously fastening the plurality of bolts to the fastening holes of the vehicle body. During this process, the door striker may be maintained in a state of being continuously attracted by the permanent magnet 320 and, as such, the door striker itself may be automatically fixed to the vehicle body when all of the plurality of bolts is fastened to the vehicle body (S600).

As described above, according to an exemplary embodiment as described above, the present disclosure may minimize a fastening location error between the door striker and the vehicle body by simultaneously picking up the door striker and the plurality of bolts, transporting the door striker and the plurality of bolts to the fastening location, precisely recognizing the fastening location through the imaging module, and performing fastening operation based on the recognized fastening location. Accordingly, it may be possible to prevent generation of a gap or looseness during door opening and closing, thereby achieving an enhancement in vehicle assembly quality.

Additionally, during the fastening process, the plurality of nut runners included in the gripper are driven in forward and reverse rotation directions to optimize the alignment between the plurality of bolts and the fastening holes. Additionally, the plurality of bolts is fastened at a predetermined torque value so that the fastening strength thereof may be uniform. Accordingly, it may be possible to prevent a variation in fastening quality.

Furthermore, it may be possible to not only prevent inconsistencies in fastening quality that may arise from differences in worker skill during manual fastening, but also to prevent a risk of scratches or damage to the vehicle body or door striker during the fastening process. Complete automation of the fastening process significantly decreases repetitive tasks for a worker, alleviating worker fatigue and improving the work environment.

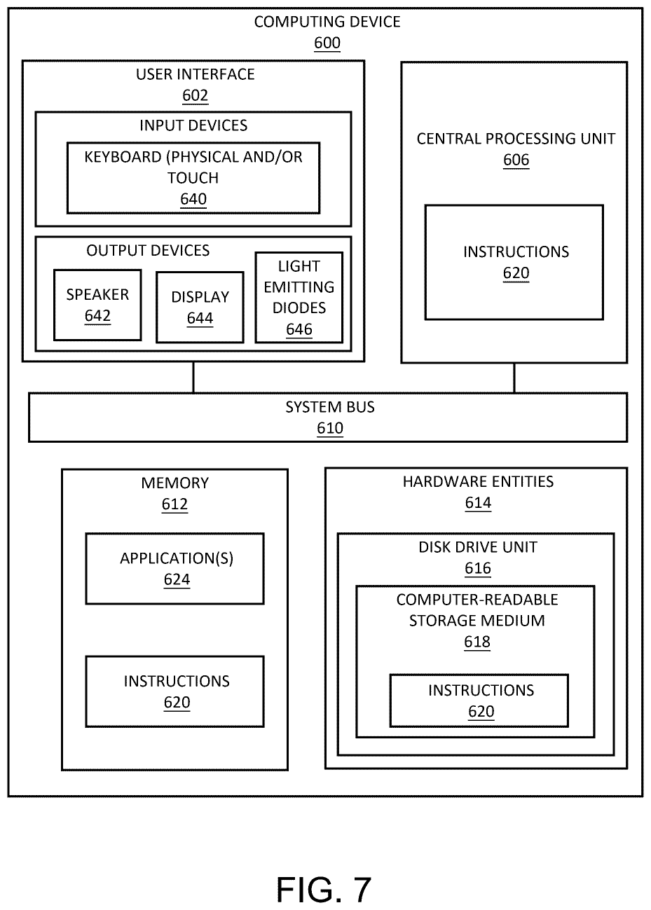

Referring now to FIG. 7, an illustration of an example architecture for a computing device 600 is provided. According to an exemplary embodiment, one or more functions of the present disclosure may be implemented by a computing device such as, e.g., computing device 600 or a computing device similar to computing device 600. Computing device 600 may be a quantum computer, a classical computer, and/or have one or more components configured to perform one or more quantum and/or classical computing functions. The processor 100, robot 200, gripper 300, imaging module 400, and/or component supply unit 500 may be examples of computing device 600 and/or may comprise one or more components of computing device 600.

The hardware architecture of FIG. 7 represents one example implementation of a representative computing device configured to implement at least a portion of the systems/devices and method(s)/control logic(s) described herein.

Some or all components of the computing device 600 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 7, the computing device 600 may comprise a user interface 602 (e.g., a graphical user interface), a Central Processing Unit (“CPU”) 606, a system bus 610, a memory 612 connected to and accessible by other portions of computing device 600 through system bus 610, and hardware entities 614 connected to system bus 610. The user interface may comprise input devices and output devices, which may be configured to facilitate user-software interactions for controlling operations of the computing device 600. The input devices may comprise, but are not limited to, a physical and/or touch keyboard 640. The input devices may be connected to the computing device 600 via a wired or wireless connection (e.g., a Bluetooth® connection). The output devices may comprise, but are not limited to, a speaker 642, a display 644, and/or light emitting diodes 646.

At least some of the hardware entities 614 may be configured to perform actions involving access to and use of memory 612, which may be a Random Access Memory (RAM), a disk driver and/or a Compact Disc Read Only Memory (CD-ROM), among other suitable memory types. Hardware entities 614 may comprise a disk drive unit 616 comprising a computer-readable storage medium 618 on which may be stored one or more sets of instructions 620 (e.g., programming instructions such as, but not limited to, software code) configured to implement one or more of the methodologies, procedures, or functions described herein. The instructions 620 may also reside, completely or at least partially, within the memory 612 and/or within the CPU 606 during execution thereof by the computing device 600.

The memory 612 and the CPU 606 may also constitute machine-readable media. The term “machine-readable media”, as used here, refers to a single medium or multiple media (e.g., a centralized or distributed database, and/or associated caches and servers) that store the one or more sets of instructions 620. The term “machine-readable media”, as used here, also refers to any medium that is capable of storing, encoding, or carrying a set of instructions 620 for execution by the computing device 600 and that cause the computing device 600 to perform any one or more of the methodologies of the present disclosure. According to various embodiments, one or more computer applications 624 may be stored on the memory 612.

Implementations described in this specification may be realized in the form of, for example, a method or procedure, an apparatus, a software program, a data stream, or a signal. Although only discussed in the context of a single form of implementation (e.g., discussed only as a method), the features discussed may also be implemented in other forms (e.g., an apparatus or a program). The apparatus may be implemented as appropriate hardware, software, firmware, or the like. The method may be implemented in an apparatus such as a processor, which generally refers to a processing device including a computer, a microprocessor, an integrated circuit, a programmable logic device or the like. The processor includes communication devices such as computers, cellular phones, portable/personal digital assistants (PDAs), or other devices that facilitate communication of information between end users.

Although the present disclosure has been described with reference to specific embodiments and drawings, it is understood that the present disclosure is not limited thereto. Skilled persons in the relevant technical field may make various modifications and variations within the spirit and the scope of the disclosure as defined by the claims and their equivalents.

What is claimed is:

1. A door striker fastening apparatus comprising:
a gripper;
a robot configured to transport a door striker and a plurality of bolts, picked up through the gripper, to a fastening location on a vehicle body; and
a computing device comprising a processor and a memory, wherein the memory is configured to store instructions that, when executed by the processor, are configured to cause the processor to:
control driving of the robot or the gripper, based on imaging data obtained through an imaging module, to fasten the door striker and the plurality of bolts to the fastening location.

2. The door striker fastening apparatus according to claim 1, wherein:
the gripper comprises:
a plurality of nut runners; and
a permanent magnet, and
the gripper is configured to pick up the door striker and the plurality of bolts, fastened to the door striker, through the plurality of nut runners and the permanent magnet.

3. The door striker fastening apparatus according to claim 2, wherein:
the gripper further comprises a holding portion corresponding to a shape of a dog of the door striker, and
the holding portion is configured to adsorb and hold the door striker through the holding portion and the permanent magnet.

4. The door striker fastening apparatus according to claim 3, wherein the holding portion is configured to dispose the dog of the door striker in a space between the plurality of nut runners.

5. The door striker fastening apparatus according to claim 2, wherein the computing device is configured to control driving of the gripper to repeatedly drive the nut runners in forward and reverse rotation directions at a predetermined rotational speed, for fastening of the nut runners to the plurality of bolts.

6. The door striker fastening apparatus according to claim 5, wherein:
the gripper comprises a cylinder configured to raise or lower the permanent magnet, and
the computing device is configured to drive the cylinder to lower the permanent magnet after the nut runners are fastened to the plurality of bolts, causing the permanent magnet to attract the door striker.

7. The door striker fastening apparatus according to claim 2, wherein:
the plurality of nut runners is disposed in a first direction identical to a direction in which the plurality of bolts fastened to the door striker is disposed, and
the permanent magnet is disposed in a second direction crossing the first direction to come into contact with a pickup surface of the door striker in order to attract the door striker.

8. The door striker fastening apparatus according to claim 2, wherein the gripper comprises a variable structure configured to vary a position of the nut runners in a height direction in accordance with a pressing force generated during a procedure of picking up the plurality of bolts by the plurality of nut runners or fastening the plurality of bolts to the vehicle body by the plurality of nut runners.

9. The door striker fastening apparatus according to claim 2, wherein the computer is configured to:
recognize one or more fastening holes of the vehicle body based on the imaging data; and
move the robot or the gripper to the fastening location based on a positional relationship between the recognized one or more fastening holes and the plurality of bolts.

10. The door striker fastening apparatus according to claim 2, wherein the computing device is configured to drive the plurality of nut runners at a predetermined torque value to simultaneously fasten the door striker and the plurality of bolts to the vehicle body.

11. A door striker fastening system for automatically fastening a door striker to a vehicle body, comprising:
a component supply unit configured to supply a door striker or a plurality of bolts;
a gripper;
a robot configured to transport the door striker and the plurality of bolts, picked up through the gripper, to a fastening location of a vehicle body; and
a computing device, comprising a processor and a memory, wherein the memory is configured to store instructions that, when executed by the processor, are configured to cause the processor to:
recognize the fastening location based on imaging data obtained through an imaging module; and
control operation of the robot or the gripper based on results of the recognition.

12. The door striker fastening system according to claim 11, wherein the gripper is configured to simultaneously pick up the door striker, supplied from the component supply unit, and the plurality of bolts inserted into the door striker and then fasten the door striker and the plurality of bolts to the vehicle body.

13. The door striker fastening system according to claim 12, wherein the component supply unit comprises:
a feeder configured to supply the plurality of bolts; and
a supplier configured to:
align the plurality of bolts supplied from the feeder; and
sequentially supply the aligned bolts.

14. The door striker fastening system according to claim 12, wherein the gripper comprises:
a nut runner configured to pick up the plurality of bolts;
a permanent magnet configured to pick up the door striker; and
a cylinder configured to raise or lower the permanent magnet.

15. The door striker fastening system according to claim 14, wherein:
the gripper is configured to repeatedly drive the nut runner in forward and reverse rotation directions at a predetermined rotational speed to fasten the nut runner to the plurality of bolts; and
the computing device is configured to drive the cylinder to lower the permanent magnet, enabling the permanent magnet to attract the door striker.

16. The door striker fastening system according to claim 12, wherein the computing device is configured to:
recognize one or more fastening holes of the vehicle body through the imaging data; and
move the robot or the gripper to the fastening location based on a positional relationship between the recognized fastening holes and the plurality of bolts.

17. A method for fastening a door striker to a vehicle body, comprising:
transporting, by a robot, a door striker and a plurality of bolts to a fastening location of a vehicle body;
moving, by a computing device comprising a processor and a memory, the robot or a gripper to the fastening location based on a positional relationship between fastening holes recognized through an imaging module and the plurality of bolts; and
fastening, by the gripper, the door striker and the plurality of bolts to the vehicle body.

18. The method according to claim 17, further comprising picking up, by the gripper, the door striker and a plurality of bolts fastened to the door striker,
wherein the gripper comprises:
a nut runner configured to pick up the plurality of bolts;
a permanent magnet configured to pick up the door striker; and
a cylinder configured to raise or lower the permanent magnet.

19. The method according to claim 18, wherein:
the picking up comprises:
repeatedly driving the nut runner in forward and reverse rotation directions at a predetermined rotational speed to fasten the nut runner to the plurality of bolts; and
subsequently driving the cylinder to lower the permanent magnet, enabling the permanent magnet to attract the door striker, and
the transporting comprises:
moving, by the computing device, the robot or the gripper to the fastening location when the plurality of bolts is fastened to the nut runner and the door striker is adsorbed to the permanent magnet.

20. The method according to claim 18, wherein the fastening comprises driving, by the gripper, the nut runner at a predetermined torque value to fasten the plurality of bolts to the vehicle body.
